(19) United States
(12) Patent Application Publication
(10) Pub. No.: US 2026/0321196 A1
(43) Pub. Date: Oct. 15, 2026

(54) LIGHT-EMITTING DRIVING CIRCUIT AND DISPLAY PANEL

(71) Applicant: Everdisplay Optronics (Shanghai) Co., Ltd., Shanghai (CN)

(72) Inventors: Ying-Hsiang TSENG, Shanghai (CN); Lina XIAO, Shanghai (CN); Qi WANG, Shanghai (CN); Jie LIU, Shanghai (CN)

(73) Assignee: Everdisplay Optronics (Shanghai) Co., Ltd., Shanghai (CN)

(21) Appl. No.: 19/474,799

(22) PCT Filed: Sep. 21, 2023
(86) PCT No.: PCT/CN2023/120245

§ 371 Date: Oct. 13, 2025

(30) Foreign Application Priority Data
Sep. 5, 2023 (CN) 202311143484.0

(51) Int. Cl. G09G 3/32

(52) U.S. Cl. CPC G09G 3/32; G09G 2300/0819; G09G 2310/0267; G09G 2320/045

(57) ABSTRACT

A light-emitting driving circuit (30) and a display panel (10). The light-emitting driving circuit (30) comprises multiple stages of light-emitting driving units and a timing controller (20), wherein each stage of light-emitting driving unit comprises 11 or 12 transistors, three capacitors (C1-C3), a signal input terminal (IN), a signal output terminal (Enout), and two timing control ends (c1, c2), and the timing controller (20) comprises a first timing control signal line (CKE1) and a second timing control signal line (CKE2).

### TECHNICAL FIELD

The present disclosure relates to the field of display panels, and in particular, to a light-emitting driving circuit and a display panel.

### BACKGROUND

The display panel includes a pixel array and a scanning driving circuit and a light-emitting driving circuit that control the pixel array. The display panel adopts a row-by-row scanning display method, in which the scanning driving circuit is used to generate a scanning signal to turn on each row of pixels in turn, and the light-emitting driving circuit is used to, when a row of pixels is turned on, provide a data signal to it to realize pixel display.

The light-emitting driving circuit includes a plurality of cascaded light-emitting driving units, where the light-emitting driving unit of each stage is usually mainly composed of a number of transistors and capacitors. By inputting a clock signal and a start pulse signal into the light-emitting driving unit, a level signal is output at the output terminal.

The Chinese patent CN105741749A provides a light-emitting driving circuit, as shown in FIGS. 1 and 2. FIG. 1 shows a circuit diagram of a light-emitting driving unit of the related art; FIG. 2 shows a waveform diagram when the light-emitting driving unit shown in FIG. 1 is working; FIG. 3 shows a schematic diagram of a conduction state of the light-emitting driving unit in the phase of Step 5 in FIG. 2, where “H” represents a high-level signal, and “L” represents a low-level signal. Referring to FIGS. 2 and 3, when the circuit enters the Step 6 moment from the Step 5 moment, the ideal circuit operation is that the low potential of the signal input terminal in is written to the second node N2 since the eighth transistor M8 is turned on due to the low potential of the second timing control signal c2, therefore the third transistor M3 is turned on, and the high potential of the first power supply VDD is written to the first node N1 to turn off the seventh transistor M7. However, when this circuit is used for a long time or there is a manufacturing process error, the aspect ratio of the transistor changes, resulting in the threshold voltage device Vth of the transistor shifting, or when the impedance of the timing control signal is too large, it may cause that the potential written to the second node N2 is too high when the circuit enters the Step 6 moment, the third transistor M3 cannot be effectively turned on, the potential of the first node N1 cannot be pulled to the high potential of the first power supply VDD, the seventh transistor M7 cannot be turned off and remains turned on, the high potential of the first power supply VDD is written to the second node N2 due to the turning on of the seventh transistor M7, the potential of the second node N2 is higher, and finally the signal output terminal out outputs the undesired low potential, causing the panel to display an abnormal picture.

It should be noted that the information disclosed in the above background section is only used to enhance the understanding of the background of the present disclosure, and therefore may include information that does not constitute the prior art known to ordinary technicians in the field.

### SUMMARY

In view of the above, the present disclosure provides a light-emitting driving circuit and a display panel, which improve the output stability of the light-emitting driving unit, reduce display abnormalities of the display panel, and increase the service life of the display panel.

One aspect of the present disclosure provides a light-emitting driving circuit, including light-emitting driving units of multiple stages, where the light-emitting driving unit includes a control module, a reset module and an output setting module;
the control module includes:
   a seventh transistor, where a first electrode of the seventh transistor is connected to a third node, a second electrode of the seventh transistor is connected to a second power supply, and a gate of the seventh transistor is connected to a first timing control;
   an eighth transistor, where a first electrode of the eighth transistor is connected to the third node, a second electrode of the eighth transistor is connected to the first timing control terminal, and a gate of the eighth transistor is connected to a signal input terminal;
   a ninth transistor, where a second electrode of the ninth transistor is connected to a first node;
the reset module includes:
   a fourth transistor, where a first electrode of the fourth transistor is connected to a first power supply, a second electrode of the fourth transistor is connected to the first node, and a gate of the fourth transistor is connected to a second node;
   a fifth transistor, where a first electrode of the fifth transistor is connected to the first power supply, and a gate of the fifth transistor is connected to a second timing control terminal;
   a sixth transistor, where a first electrode of the sixth transistor is connected to a second electrode of the fifth transistor, and a second electrode of the sixth transistor is connected to the second node.

In some embodiments, the control module further includes:
a twelfth transistor, where a first electrode of the twelfth transistor is connected to a gate of the ninth transistor, a second electrode of the twelfth transistor is connected to the third node, and a gate of the twelfth transistor is connected to the second power supply;
a gate of the sixth transistor is connected to the third node.

In some embodiments, the gate of the ninth transistor is connected to the third node;
a gate of the sixth transistor is connected to the first node.

In some embodiments, the output setting module includes:
a first transistor, where a first electrode of the first transistor is connected to the first power supply, a second electrode of the first transistor is connected to a signal output terminal, and a gate of the first transistor is connected to the first node;
a second transistor, where a first electrode of the second transistor is connected to the signal output terminal, a second electrode of the second transistor is connected to the second power supply, and a gate of the second transistor is connected to a fourth node;
a third transistor, where a first electrode of the third transistor is connected to the second node, a second electrode of the third transistor is connected to the fourth node, and a gate of the third transistor is connected to the second power supply;
a tenth transistor, where a first electrode of the tenth transistor is connected to the second power supply, a second electrode of the tenth transistor is connected to a first electrode of the ninth transistor, and a gate of the tenth transistor is connected to the second timing control terminal; and
an eleventh transistor, where a first electrode of the eleventh transistor is connected to the signal input terminal, a second electrode of the eleventh transistor is connected to the second node, and a gate of the eleventh transistor is connected to the first timing control terminal.

In some embodiments, the light-emitting driving unit further includes:
a first capacitor, where a first electrode of the first capacitor is connected to the second timing control terminal, and a second electrode of the first capacitor is connected to the fourth node;
a second capacitor, where a first electrode of the second capacitor is connected to the second timing control terminal, and a second electrode of the second capacitor is connected to the gate of the ninth transistor; and
a third capacitor, where a first electrode of the third capacitor is connected to the first power supply, and a second electrode of the third capacitor is connected to the first node.

In some embodiments, a timing controller is further included, and the timing controller includes a first timing control signal line and a second timing control signal line.

In some embodiments, the first timing control signal line is used to output a first timing control signal; and the second timing control signal line is used to output a second timing control signal.

In some embodiments, the first timing control signal and the second timing control signal are square wave signals with a same output frequency and a phase difference of 180°.

In some embodiments, the light-emitting driving unit is used to perform delay processing on a signal received from the signal input terminal under a control of the first timing control signal and the second timing control signal, and the processed signal is output by the signal output terminal.

In some embodiments, a light-emitting driving unit of a previous stage outputs a light-emitting driving signal to a light-emitting driving unit of a next stage, and a light-emitting driving unit of a last stage outputs a light-emitting driving signal.

In some embodiments, in a light-emitting driving unit of an odd-numbered stage, the first timing control terminal is connected to the first timing control signal line, and the second timing control terminal is connected to the second timing control signal line.

In some embodiments, in a light-emitting driving unit of an even-numbered stage, the first timing control terminal is connected to the second timing control signal line, and the second timing control terminal is connected to the first timing control signal line.

In some embodiments, the first transistor to the eleventh transistor are all P-type MOS transistors.

Another aspect of the present disclosure further provides a display panel, including any one of the above-mentioned light-emitting driving circuits.

The beneficial effects of the present disclosure compared with the related art include at least the follows.

The light-emitting driving circuit and display panel of the present disclosure provide a new light-emitting driving circuit so that the first node, the second node and the third node are independently controlled to avoid the mutual restraint and influence of the three nodes, thereby improving the output stability of the light-emitting driving unit, reducing the display abnormality of the display panel, and increasing the service life of the display panel; in addition, the present disclosure reduces the number of components of the light-emitting driving circuit by reducing the use of the timing control signal line, thereby reducing the border width of the display panel and adapting to the trend of narrow borders of the display panels.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated into and constitute a part of the specification, illustrate embodiments consistent with the present disclosure, and together with the specification, serve to explain the principles of the present disclosure. Obviously, the accompanying drawings described below are only some embodiments of the present disclosure, and for those of ordinary skill in the art, other accompanying drawings can be obtained based on these accompanying drawings without creative work.

FIG. 1 shows a circuit diagram of a light-emitting driving unit in the related art;

FIG. 2 shows a waveform diagram when the light-emitting driving unit shown in FIG. 1 is working;

FIG. 3 is a schematic diagram showing a conduction state of the light-emitting driving unit in Step 5 phase of FIG. 2;

FIG. 4 is a schematic diagram showing a display panel of the present disclosure;

FIG. 5 is a schematic diagram showing a cascade connection of the light-emitting driving circuits of the present disclosure;

FIG. 6 shows a circuit diagram of a light-emitting driving unit according to a first embodiment of the present disclosure;

FIG. 7 shows a waveform diagram when the light-emitting driving unit shown in FIG. 6 is working;

FIG. 8 is a schematic diagram showing a conduction state of the light-emitting driving unit in the Step 11 phase in FIG. 7;

FIG. 9 is a schematic diagram showing a conduction state of the light-emitting driving unit in the Step 12 phase in FIG. 7;

FIG. 10 is a schematic diagram showing a conduction state of the light-emitting driving unit in the Step 13 phase in FIG. 7;

FIG. 11 is a schematic diagram showing a conduction state of the light-emitting driving unit in the Step 14 phase in FIG. 7;

FIG. 12 is a schematic diagram showing the conduction state of the light-emitting driving unit in the Step 15 stage in FIG. 7;

FIG. 13 is a schematic diagram showing a conduction state of the light-emitting driving unit in the Step 16 phase in FIG. 7;

FIG. 14 shows a circuit diagram of a light-emitting driving unit according to a second embodiment of the present disclosure;

FIG. 15 shows a waveform diagram when the light-emitting driving unit shown in FIG. 14 is working;

FIG. 16 is a schematic diagram showing a conduction state of the light-emitting driving unit in the Step 21 phase in FIG. 15;

FIG. 17 is a schematic diagram showing a conduction state of the light-emitting driving unit in the Step 22 phase in FIG. 15;

FIG. 18 is a schematic diagram showing a conduction state of the light-emitting driving unit in the Step 23 stage in FIG. 15;

FIG. 19 is a schematic diagram showing a conduction state of the light-emitting driving unit in the Step 24 phase in FIG. 15;

FIG. 20 is a schematic diagram showing a conduction state of the light-emitting driving unit in the Step 25 stage in FIG. 15;

FIG. 21 is a schematic diagram showing the conduction state of the light-emitting driving unit in the Step 26 stage in FIG. 15.

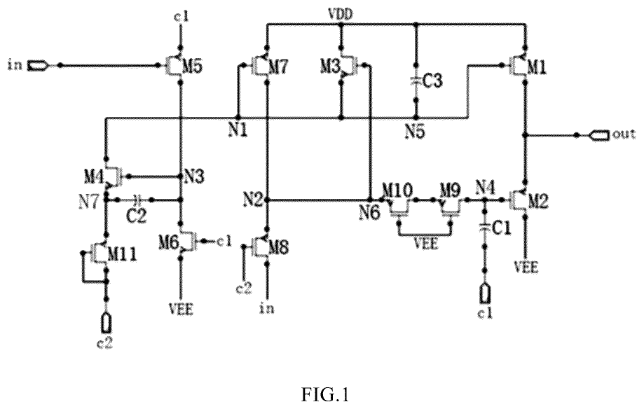

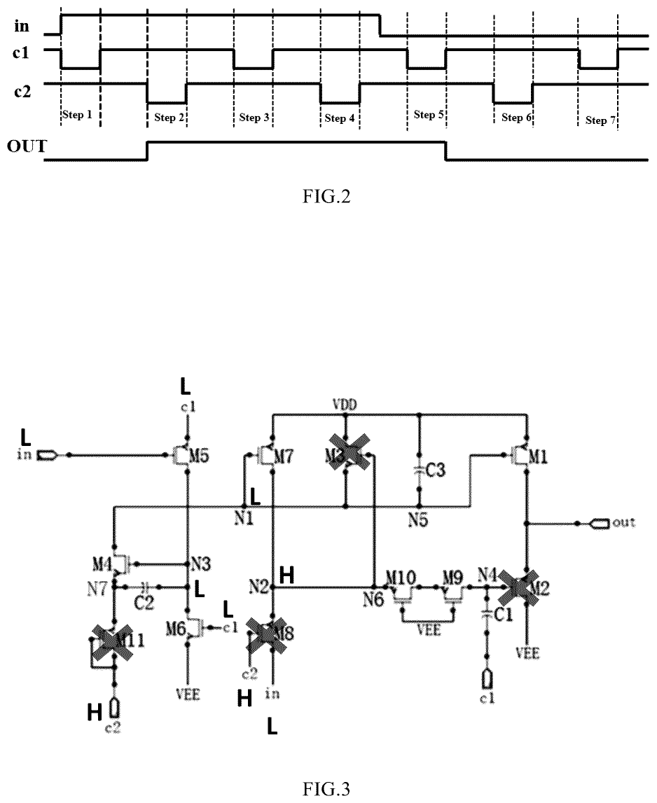

Reference signs:
10 Display panel
11 Display area
20 Timing controller
30 Light-emitting driving circuit
CKE1 First timing control signal line
CKE2 Second timing control signal line
c1 First timing control terminal
c2 Second timing control terminal
IN Signal input terminal
Enout Signal output terminal
M1 First transistor
M2 Second transistor
M3 Third transistor
M4 Fourth transistor
M5 Fifth transistor
M6 Sixth transistor
M7 Seventh transistor
M8 Eighth transistor
M9 Ninth transistor
M10 Tenth transistor
M11 Eleventh transistor
M12 Twelfth transistor
C1 First capacitor
C2 Second capacitor
C3 Third capacitor
VDD First power supply
VEE Second power supply
N1 First node
N2 Second node
N3 Third node
N4 Fourth node

### DETAILED DESCRIPTION

Example embodiments will now be described more fully with reference to the accompanying drawings. However, the example embodiments can be implemented in a variety of forms and should not be construed as limited to the embodiments set forth herein. Rather, these embodiments are provided so that the present disclosure will be comprehensive and complete and fully convey the concepts of the example embodiments to those skilled in the art. The same reference signs in the figures represent the same or similar structures, and thus their repeated description will be omitted.

The terms “first”, “second” and similar terms used in the specific description do not indicate any order, quantity or importance, but are only used to distinguish different components. In addition, in the description of the present disclosure, the orientations or positional relationships indicated by the terms “upper” and “lower” are the orientations or positional relationships shown in the drawings. They are only for the convenience of description and do not indicate or imply that the apparatuses or components referred to must have a specific orientation, be constructed and operate in a specific orientation. Therefore, it should not be understood that they are not intended to limit the present disclosure.

It should be noted that, in the absence of conflict, the embodiments and features in different embodiments of the present disclosure may be combined with each other.

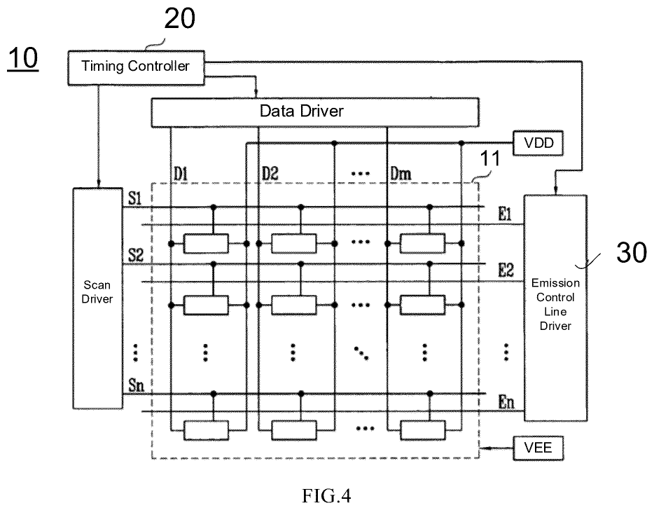

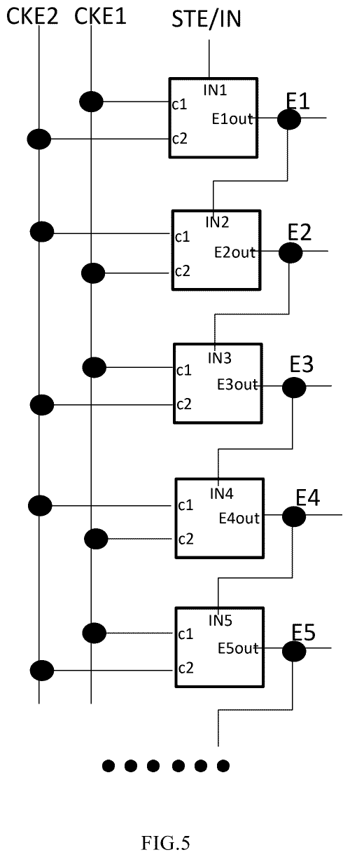

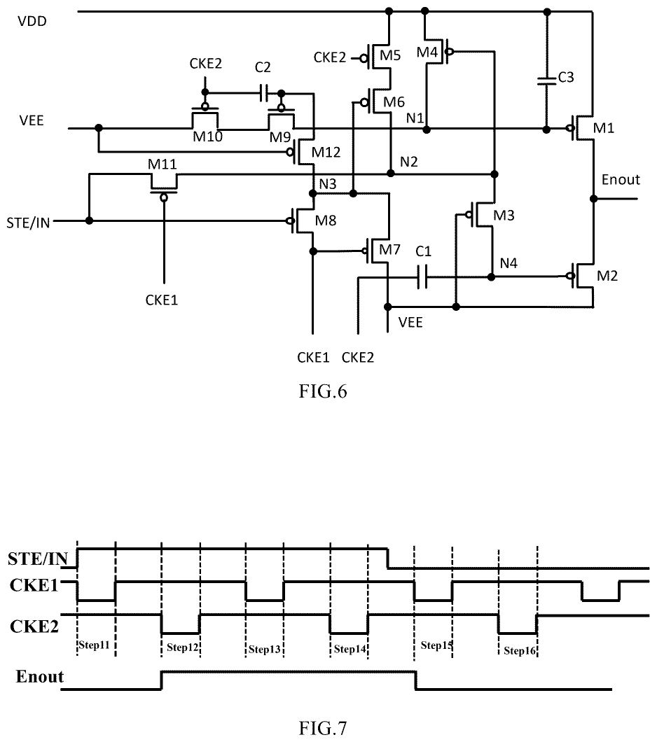

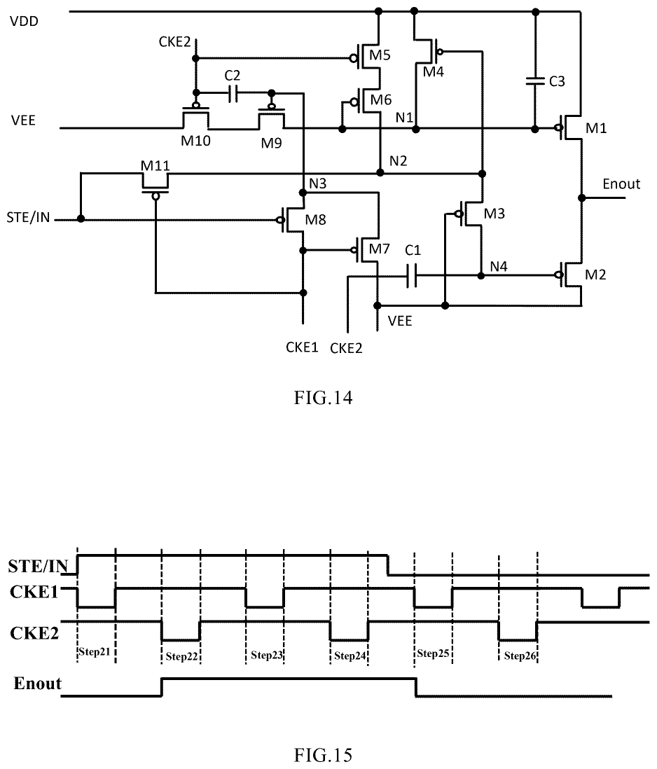

The inventor of the present application has provided a solution to the problem existing in the related art through careful and in-depth research. FIG. 4 shows a schematic diagram of a display panel of the present disclosure; FIG. 5 shows a schematic diagram of cascade of the light-emitting driving circuits of the present disclosure; FIG. 6 shows a circuit diagram of the light-emitting driving unit of the first embodiment of the present disclosure; and FIG. 14 shows a circuit diagram of the light-emitting driving unit of the second embodiment of the present disclosure. As shown in FIGS. 4, 5, 6 and 14, the present disclosure discloses a light-emitting driving circuit 30 and a display panel 10, where the light-emitting driving circuit 30 includes light-emitting driving units of multiple stages and a timing controller 20. Each stage of the light-emitting driving unit includes a control module, a reset module and an output setting module, specifically including 11 or 12 transistors, 3 capacitors, a signal input terminal, a signal output terminal and two timing control terminals. The timing controller 20 includes two timing control signal lines. In addition, the light-emitting driving unit includes three nodes. The light-emitting driving circuit and the display panel of the present disclosure provide a new light-emitting driving circuit, so that the first node N1, the second node N2 and the third node N3 are independently controlled to avoid the mutual restraint and influence of the three, thereby improving the output stability of the light-emitting driving unit, reducing the display abnormality of the display panel, and increasing the service life of the display panel; in addition, the present disclosure reduces the number of components of the light-emitting driving circuit by reducing the use of the timing control signal line, thereby reducing the border width of the display panel and adapting to the trend of narrow borders of display panels.

The specific implementations of the present disclosure are further described in detail below with reference to the accompanying drawings.

As shown in FIG. 4, the present disclosure provides a display panel 10, which includes a display area 11 and a non-display area. The light-emitting driving circuit 30, the data driver and the scanning driving circuit are located in the non-display area of the display panel 10. The display area 11 includes light-emitting pixels and pixel circuits arranged in an array. The light-emitting pixel emits light under the joint action of the light-emitting driving circuit 30, the data driver, the scanning driving circuit and the pixel circuit.

As shown in FIGS. 4 and 5, the present disclosure further provides a light-emitting driving circuit 30, which includes light-emitting driving units of multiple stages and a timing controller 20.

In some embodiments, the light-emitting driving unit includes 11 or 12 transistors, 3 capacitors, a signal input terminal IN, a signal output terminal Enout, a first timing control terminal c1, and a second timing control terminal c2. Each stage of light-emitting driving unit outputs a light-emitting driving signal, which is input into a row of pixel circuits in the display area 11 of the display panel 10 to drive the pixels in the row to emit light. The light-emitting driving unit of the previous stage simultaneously outputs the light-emitting driving signal to the signal input terminal IN of the light-emitting driving unit of the next stage as a start signal. Since the light-emitting driving unit of the last stage does not have a next stage, the light-emitting driving signal outputted by the light-emitting driving unit of the last stage is only input into the pixel circuit in the row.

Specifically, in FIG. 5, five cascaded light-emitting driving units are taken as an example, and the start pulse signal STE is inputted into the signal input terminal IN1 of the first-stage light-emitting driving unit E1 as an input signal. The signal output terminal E1out of the first-stage light-emitting driving unit E1 outputs a light-emitting driving signal as an input signal of the second-stage light-emitting driving unit E2, and the signal output terminal E1out of the first-stage light-emitting driving unit E1 is connected to the signal input terminal IN2 of the second-stage light-emitting driving unit E2. The signal output terminal E2out of the second-stage light-emitting driving unit E2 outputs a light-emitting driving signal as an input signal of the third-stage light-emitting driving unit E3, and the signal output terminal E2out of the second-stage light-emitting driving unit E2 is connected to the signal input terminal IN3 of the third-stage light-emitting driving unit E3. The signal output terminal E3out of the third-stage light-emitting driving unit E3 outputs a light-emitting driving signal as an input signal of the fourth-stage light-emitting driving unit E4, and the signal output terminal E3out of the third-stage light-emitting driving unit E3 is connected to the signal input terminal IN4 of the fourth-stage light-emitting driving unit E4. The signal output terminal E4out of the fourth-stage light-emitting driving unit E4 outputs a light-emitting driving signal as an input signal of the fifth-stage light-emitting driving unit E5, and the signal output terminal E4out of the fourth-stage light-emitting driving unit E4 is connected to the signal input terminal IN5 of the fifth-stage light-emitting driving unit E5 . . . The subsequent-stage light-emitting driving units repeat this to form the light-emitting driving circuit 30.

FIG. 7 shows a waveform diagram when the light-emitting driving unit shown in FIG. 6 is working; FIG. 15 shows a waveform diagram when the light-emitting driving unit shown in FIG. 14 is working. In some embodiments, as shown in FIGS. 5, 7 and 15, the timing controller 20 includes a first timing control signal line CKE1 and a second timing control signal line CKE2. The first timing control signal line CKE1 is used to output a first timing control signal.

The second timing control signal line CKE2 is used to output a second timing control signal.

The first timing control signal and the second timing control signal are square wave signals with the same output frequency and a phase difference of 180°.

In some embodiments, as shown in FIG. 5, in the first-stage light-emitting driving unit, the first timing control terminal c1 is connected to the first timing control signal line CKE1 for receiving the first timing control signal. The second timing control terminal c2 is connected to the second timing control signal line CKE2 for receiving the second timing control signal. In the second-stage light-emitting driving unit, the first timing control terminal c1 is connected to the second timing control signal line CKE2 for receiving the second timing control signal. The second timing control terminal c2 is connected to the first timing control signal line CKE1, for receiving the first timing control signal. In the third-stage light-emitting driving unit, the first timing control terminal c1 is connected to the first timing control signal line CKE1, for receiving the first timing control signal. The second timing control terminal c2 is connected to the second timing control signal line CKE2, for receiving the second timing control signal. In the fourth-stage light-emitting driving unit, the first timing control terminal c1 is connected to the second timing control signal line CKE2, for receiving the second timing control signal. The second timing control terminal c2 is connected to the first timing control signal line CKE1, for receiving the first timing control signal. In the fifth-stage light-emitting driving unit, the first timing control terminal c1 is connected to the first timing control signal line CKE1, for receiving the first timing control signal. The second timing control terminal c2 is connected to the second timing control signal line CKE2 for receiving the second timing control signal, and so on. It is obtained that: in the odd-stage light-emitting driving units, the first timing control terminal c1 is connected to the first timing control signal line CKE1 for receiving the first timing control signal, and the second timing control terminal c2 is connected to the second timing control signal line CKE2 for receiving the second timing control signal. In the even-stage light-emitting driving units, the first timing control terminal c1 is connected to the second timing control signal line CKE2 for receiving the second timing control signal, and the second timing control terminal c2 is connected to the first timing control signal line CKE1 for receiving the first timing control signal.

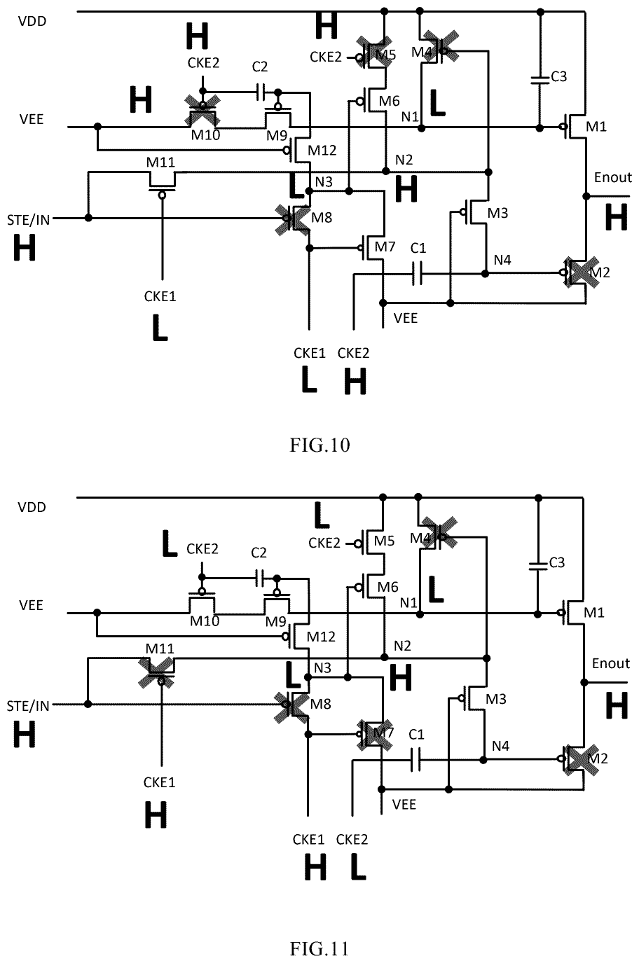

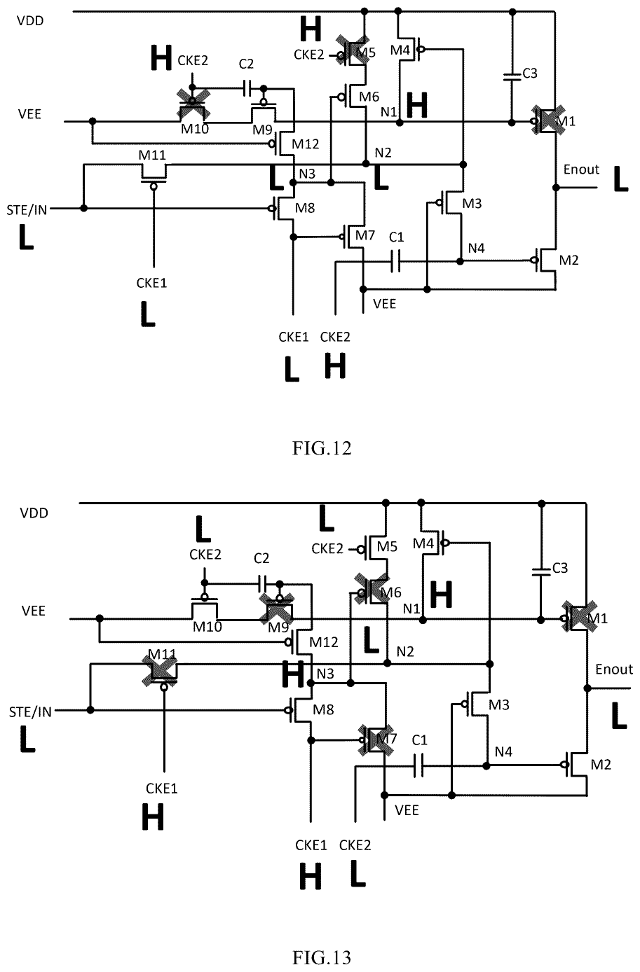

In the first embodiment of the present disclosure, referring to FIGS. 4 to 13, FIG. 8 shows a schematic diagram of the conduction state of the light-emitting driving unit in the Step 11 phase of FIG. 7; FIG. 9 shows a schematic diagram of the conduction state of the light-emitting driving unit in the Step 12 phase of FIG. 7; FIG. 10 shows a schematic diagram of the conduction state of the light-emitting driving unit in the Step 13 phase of FIG. 7; FIG. 11 shows a schematic diagram of the conduction state of the light-emitting driving unit in the Step 14 phase of FIG. 7; FIG. 12 shows a schematic diagram of the conduction state of the light-emitting driving unit in the Step 15 phase of FIG. 7; and FIG. 13 shows a schematic diagram of the conduction state of the light-emitting driving unit in the Step 16 phase of FIG. 7.

In this embodiment, as shown in FIG. 6, each stage of the light-emitting driving unit includes a control module, a reset module and an output setting module. Specifically, the light-emitting driving unit includes 12 transistors, 3 capacitors, a signal input terminal IN, a signal output terminal Enout, a first timing control terminal c1 and a second timing control terminal c2.

In this embodiment, the control module includes: a seventh transistor M7, an eighth transistor M8 and a ninth transistor M9. The first electrode of the seventh transistor M7 is connected to the third node N3, the second electrode is connected to the second power supply VEE, and the gate is connected to the first timing control. The first electrode of the eighth transistor M8 is connected to the third node N3, the second electrode is connected to the first timing control terminal c1, and the gate is connected to the signal input terminal IN. The second electrode of the ninth transistor M9 is connected to the first node N1. In addition, in this embodiment, the control module further includes: a twelfth transistor M12. The first electrode of the twelfth transistor M12 is connected to the gate of the ninth transistor M9, the second electrode is connected to the third node N3, and the gate is connected to the second power supply VEE.

In this embodiment, the reset module includes: a fourth transistor M4, a fifth transistor M5 and a sixth transistor M6. The first electrode of the fourth transistor M4 is connected to the first power supply VDD, the second electrode is connected to the first node N1, and the gate is connected to the second node N2. The first electrode of the fifth transistor M5 is connected to the first power supply VDD, and the gate is connected to the second timing control terminal c2. The first electrode of the sixth transistor M6 is connected to the second electrode of the fifth transistor M5, and the second electrode is connected to the second node N2. In addition, in this embodiment, the gate of the sixth transistor M6 is connected to the third node N3.

In this embodiment, the output setting module includes: a first transistor M1, a second transistor M2, a third transistor M3, a tenth transistor M10 and an eleventh transistor M11. The first electrode of the first transistor M1 is connected to the first power supply VDD, the second electrode is connected to the signal output terminal Enout, and the gate is connected to the first node N1. The first electrode of the second transistor M2 is connected to the signal output terminal Enout, the second electrode is connected to the second power supply VEE, and the gate is connected to the fourth node N4. The first electrode of the third transistor M3 is connected to the second node N2, the second electrode is connected to the fourth node N4, and the gate is connected to the second power supply VEE. The first electrode of the tenth transistor M10 is connected to the second power supply VEE, the second electrode is connected to the first electrode of the ninth transistor M9, and the gate is connected to the second timing control terminal c2. The first electrode of the eleventh transistor M11 is connected to the signal input terminal IN, the second electrode is connected to the second node N2, and the gate is connected to the first timing control terminal c1.

In this embodiment, the light-emitting driving unit further includes: a first capacitor C1, a second capacitor C2 and a third capacitor C3. The first electrode of the first capacitor C1 is connected to the second timing control terminal c2, and the second electrode is connected to the fourth node N4. The first electrode of the second capacitor C2 is connected to the second timing control terminal c2, and the second electrode is connected to the gate of the ninth transistor M9. The first electrode of the third capacitor C3 is connected to the first power supply VDD, and the second electrode is connected to the first node N1.

In this embodiment, the first transistor M1 to the twelfth transistor M12 are all P-type MOS transistors. The control terminal of the PMOS transistor is the gate, the first electrode is the source, the second electrode is the drain, or the first electrode is the drain, and the second electrode is the source. The turn-on level of the PMOS transistor is a low level, and the turn-off level is a high level. In some other embodiments, those skilled in the art will can easily conclude that the light-emitting driving units provided by the present disclosure can be easily changed to all N-type MOS transistors. In addition, the light-emitting driving units provided by the present disclosure can also be easily changed to CMOS transistors.

In this embodiment, referring to FIG. 7, the waveform diagram shown in FIG. 7 includes 6 specific processes: Step 11 to Step 16, and subsequent processes not shown. In these processes, the output signal of the signal output terminal Enout of the above-mentioned light-emitting driving unit completes a process from setting to resetting. It should be noted that, for ease of understanding, in the accompanying drawings, the high-level signal is represented by “H” and the low-level signal is represented by “L”. The relationship between the input and output of the light-emitting driving unit in the above 6 processes is analyzed below in combination with the waveform diagram of FIG. 7 and the circuit diagram of FIG. 6.

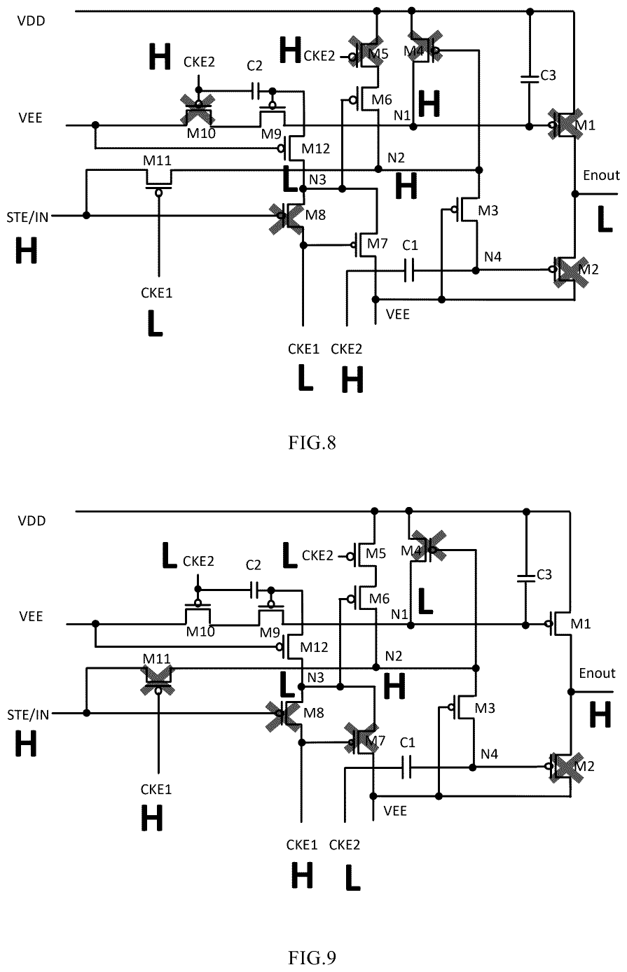

In this embodiment, referring to FIGS. 7 and 8, in the process of Step 11, a high level is inputted into the signal input terminal IN, a low level is inputted into the first timing control signal line CKE1, and a high level is inputted into the second timing control signal line CKE2. At this time, the third transistor M3, the sixth transistor M6, the seventh transistor M7, the ninth transistor M9, the eleventh transistor M11, and the twelfth transistor M12 are turned on, and the first transistor M1, the second transistor M2, the fourth transistor M4, the fifth transistor M5, the eighth transistor M8, and the tenth transistor M10 are turned off. Specifically, a low level is inputted into the first timing control signal line CKE1, the seventh transistor M7 and the eleventh transistor M11 are turned on, the second node N2 and the third node N3 are respectively written with the high potential of the signal input terminal IN and the low potential of the second power supply VEE, the second transistor M2 and the fourth transistor M4 are turned off, the third node N3 is written with a low potential, and the sixth transistor M6 and the ninth transistor M9 are turned on. A high level is inputted into the second timing control signal line CKE2, the fifth transistor M5 and the tenth transistor M10 are turned off, the first node N1 maintains the high potential of the previous moment, and the first transistor M1 is turned off.

Finally, the signal output terminal Enout maintains the low potential of the previous moment.

In the present embodiment, referring to FIGS. 7 and 9, in the process of Step 12, a high level is inputted into the signal input terminal IN, a high level is inputted into the first timing control signal line CKE1, and a low level is inputted into the second timing control signal line CKE2.

At this time, the first transistor M1, the third transistor M3, the fifth transistor M5, the sixth transistor M6, the ninth transistor M9, the tenth transistor M10, and the twelfth transistor M12 are turned on, and the second transistor M2, the fourth transistor M4, the seventh transistor M7, the eighth transistor M8, and the eleventh transistor M11 are turned off. Specifically, a high level is inputted into the first timing control signal line CKE1, the seventh transistor M7 and the eleventh transistor M11 are turned off, the third node N3 maintains the low potential of the previous moment, and the sixth transistor M6 and the ninth transistor M9 are turned on. At the same time, a low level is inputted into the second timing control signal line CKE2, the fifth transistor M5 and the tenth transistor M10 are turned on, the first node N1 is written with the low potential of the second power supply VEE due to the turning on of the ninth transistor M9 and the tenth transistor M10, and the second node N2 is written with the high potential of the first power supply VDD due to the turning on of the fifth transistor M5 and the sixth transistor M6. The high potential of the second node N2 causes the second transistor M2 and the fourth transistor M4 to be turned off, and the low potential of the first node N1 causes the first transistor MI to be turned on. Finally, the signal output terminal Enout outputs the high potential of the first power supply VDD.

In the present embodiment, referring to FIGS. 7 and 10, in the process of Step 13, a high level is inputted into the signal input terminal IN, a low level is inputted into the first timing control signal line CKE1, and a high level is inputted into the second timing control signal line CKE2.

At this time, the first transistor M1, the third transistor M3, the sixth transistor M6, the seventh transistor M7, the ninth transistor M9, the eleventh transistor M11, and the twelfth transistor M12 are turned on, and the second transistor M2, the fourth transistor M4, the fifth transistor M5, the eighth transistor M8, and the tenth transistor M10 are turned off. Specifically, a low level is inputted into the first timing control signal line CKE1, the seventh transistor M7 and the eleventh transistor M11 are turned on, and the second node N2 and the third node N3 are respectively written with the high potential of the signal input terminal IN and the low potential of the second power supply VEE. The high potential of the second node N2 causes the second transistor M2 and the fourth transistor M4 to be turned off. The low potential of the third node N3 causes the sixth transistor M6 and the ninth transistor M9 to be turned on. A high level is inputted into the second timing control signal line CKE2, the fifth transistor M5 and the tenth transistor M10 are turned off, and the first node N1 maintains the low potential of the previous moment. The high potential of the second node N2 causes the second transistor M2 to be turned off. The low potential of the first node N1 causes the first transistor MI to be turned on. Finally, the signal output terminal Enout outputs the high potential of the first power supply VDD.

In this embodiment, referring to FIGS. 7 and 11, in the process of Step 14, a high level is inputted into the signal input terminal IN, a high level is inputted into the first timing control signal line CKE1, and a low level is inputted into the second timing control signal line CKE2.

At this time, the first transistor M1, the third transistor M3, the fifth transistor M5, the sixth transistor M6, the ninth transistor M9, the tenth transistor M10 and the twelfth transistor M12 are turned on, and the second transistor M2, the fourth transistor M4, the seventh transistor M7, the eighth transistor M8 and the eleventh transistor M11 are turned off. Specifically, a high level is inputted into the first timing control signal line CKE1, the seventh transistor M7 and the eleventh transistor M11 are turned off, the third node N3 maintains the low potential of the previous moment, the sixth transistor M6 and the ninth transistor M9 are turned on, and at the same time, a low level is inputted into the second timing control signal line CKE2, the fifth transistor M5 and the tenth transistor M10 are turned on, and the first node N1 is written with the low potential of the second power supply VEE because the turning on of the ninth transistor M9 and the tenth transistor M10, and the second node N2 is written with the high potential of the first power supply VDD due to the turning on of the fifth transistor M5 and the sixth transistor M6. The high potential of the second node N2 causes the second transistor M2 to be turned off, and the low potential of the first node N1 causes the first transistor M1 to be turned on. Finally, the signal output terminal Enout outputs the high potential of the first power supply VDD.

In the present embodiment, referring to FIGS. 7 and 12, in the process of Step 15, a low level is inputted into the signal input terminal IN, a low level is inputted into the first timing control signal line CKE1, and a high level is inputted into the second timing control signal line CKE2.

At this time, the second transistor M2, the third transistor M3, the fourth transistor M4, the sixth transistor M6, the seventh transistor M7, the eighth transistor M8, the ninth transistor M9, the eleventh transistor M11, and the twelfth transistor M12 are turned on, and the first transistor M1, the fifth transistor M5, and the tenth transistor M10 are turned off. Specifically, a low level is inputted into the first timing control signal line CKE1, the second node N2 is written with the low level of the signal input terminal IN due to the turning on of the eleventh transistor M11, and the third node N3 is written with the low levels of the first timing control signal line CKE1 and the second power supply VEE respectively at the same time due to the turning on of the seventh transistor M7 and the eighth transistor M8, and then the ninth transistor M9 is turned on. A high level is inputted into he second timing control signal line CKE2, the fifth transistor M5 and the tenth transistor M10 are turned off, and the first node N1 is written with a high potential of the first power supply VDD due to the turning on of the fourth transistor M4 caused by the low potential of the second node N2. The high potential of the first node N1 causes the first transistor M1 to be turned off. The low potential of the second node N2 causes the second transistor M2 to be turned on. Finally, the signal output terminal Enout outputs the low potential of the second power supply VEE.

In the present embodiment, referring to FIGS. 7 and 13, in the process of Step 16, a low level is inputted into the signal input terminal IN, a high level is inputted into the first timing control signal line CKE1, and a low level is inputted into the second timing control signal line CKE2.

At this time, the second transistor M2, the third transistor M3, the fourth transistor M4, the fifth transistor M5, the eighth transistor M8, the tenth transistor M10, and the twelfth transistor M12 are turned on, and the first transistor M1, the sixth transistor M6, the seventh transistor M7, the ninth transistor M9, and the eleventh transistor M11 are turned off. Specifically, a high level is inputted into the first timing control signal line CKE1, the seventh transistor M7 and the eleventh transistor M11 are turned off, and the third node N3 is written with the high potential of the first timing control signal line CKE1 due to the eighth transistor M8 being turned on due to the low level inputted to the signal input terminal IN, and the ninth transistor M9 is turned off. At the same time, a low level is inputted into the second timing control signal line CKE2, the fifth transistor M5 and the tenth transistor M10 are turned on, the second node N2 maintains the low potential of the previous moment, and the first node N1 is written with the high potential of the first power supply VDD due to the turning on of the fourth transistor M4 caused by the low potential of the second node N2. The high potential of the first node N1 causes the first transistor M1 to be turned off. The low potential of the second node N2 causes the second transistor M2 to be turned on. Finally, the signal output terminal Enout outputs the low potential of the second power source VEE.

In this embodiment, the light-emitting driving unit repeats the process from Step 15 to Step 16 after Step 16 until the next frame begins to be displayed, the start pulse signal STE or the signal input terminal IN are inputted with a high potential, and the next round of Step 11 process is re-entered.

In this embodiment, the relationship between the input and output of the light-emitting driving unit is: when the start pulse signal STE or the signal input terminal IN is inputted with a high-level signal at the beginning of a certain process, the signal output terminal Enout outputs a high-level signal when the next process starts; when the start pulse signal STE or the signal input terminal IN is inputted with a low-level signal in a certain process, the signal output terminal Enout outputs a low-level signal when the current process ends and the next process starts. At other times, the signal output by the signal output terminal Enout and the signal input by the start pulse signal STE or the signal input terminal IN are both low-level signals.

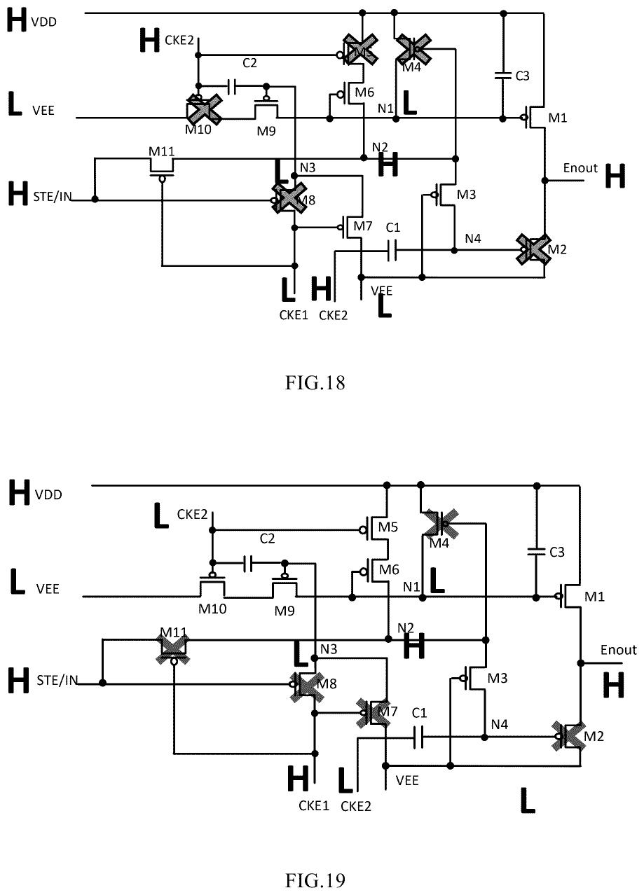

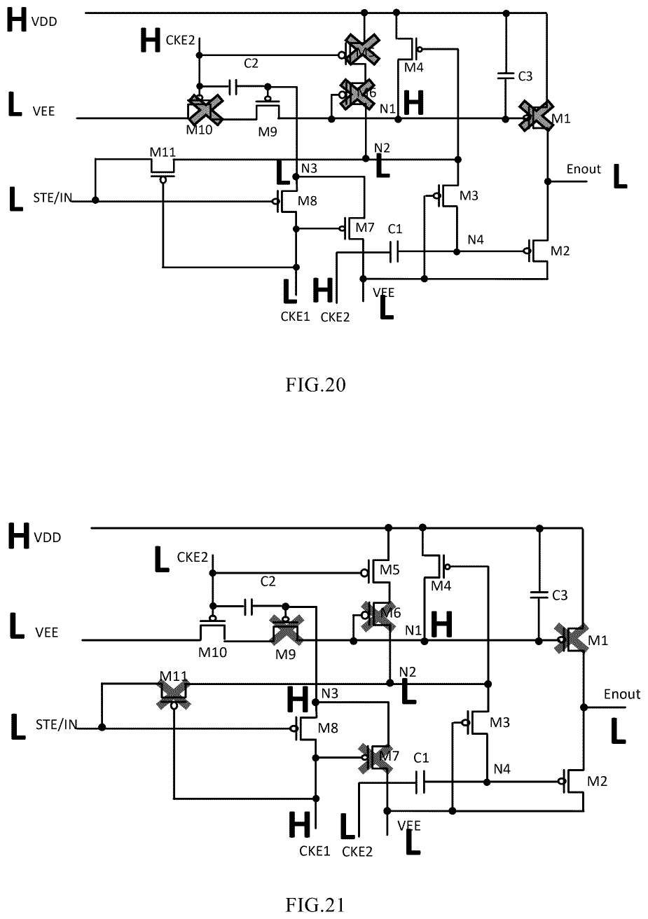

In the second embodiment of the present disclosure, referring to FIGS. 4 to 5 and 14 to 21, FIG. 16 shows a schematic diagram of the conduction state of the light-emitting driving unit in the Step 21 phase of FIG. 15; FIG. 17 shows a schematic diagram of the conduction state of the light-emitting driving unit in the Step 22 phase of FIG. 15; FIG. 18 shows a schematic diagram of the conduction state of the light-emitting driving unit in the Step 23 phase of FIG. 15; FIG. 19 shows a schematic diagram of the conduction state of the light-emitting driving unit in the Step 24 phase of FIG. 15; FIG. 20 shows a schematic diagram of the conduction state of the light-emitting driving unit in the Step 25 phase of FIG. 15; and FIG. 21 shows a schematic diagram of the conduction state of the light-emitting driving unit in the Step 26 phase of FIG. 15.

In this embodiment, as shown in FIG. 14, each stage of the light-emitting driving unit includes a control module, a reset module and an output setting module. Specifically, the light-emitting driving unit includes 11 transistors, 3 capacitors, a signal input terminal IN, a signal output terminal Enout, a first timing control terminal c1 and a second timing control terminal c2.

In this embodiment, the control module is different from the first embodiment in that the twelfth transistor is not included, and the gate of the ninth transistor M9 is connected to the third node N3. The similarities are not repeated here.

In this embodiment, the reset module is different from the first embodiment in that the gate of the sixth transistor M6 is connected to the first node N1. The similarities are not repeated here.

In this embodiment, the output setting module is the same as that in the first embodiment, and will not be described in detail here.

In this embodiment, the light-emitting driving unit further includes: a first capacitor C1, a second capacitor C2 and a third capacitor C3. The connection manner thereof is the same as that of the first embodiment, and will not be described again.

In this embodiment, the specific selection of the first transistor M1 to the eleventh transistor M11 is the same as that of the first embodiment, and will not be repeated here.

In this embodiment, referring to FIG. 15, the waveform diagram shown in FIG. 15 includes 6 processes: Step 21 to Step 26, and subsequent processes not shown. In these processes, the output signal of the signal output terminal Enout of the above-mentioned light-emitting driving unit completes a process from setting to resetting. It should be noted that, for ease of understanding, in the accompanying drawings, the high-level signal is represented by “H”, and the low-level signal is represented by “L”. The relationship between the input and output of the light-emitting driving unit in the above 6 processes is analyzed below in combination with the waveform diagram of FIG. 15 and the circuit diagram of FIG. 14.

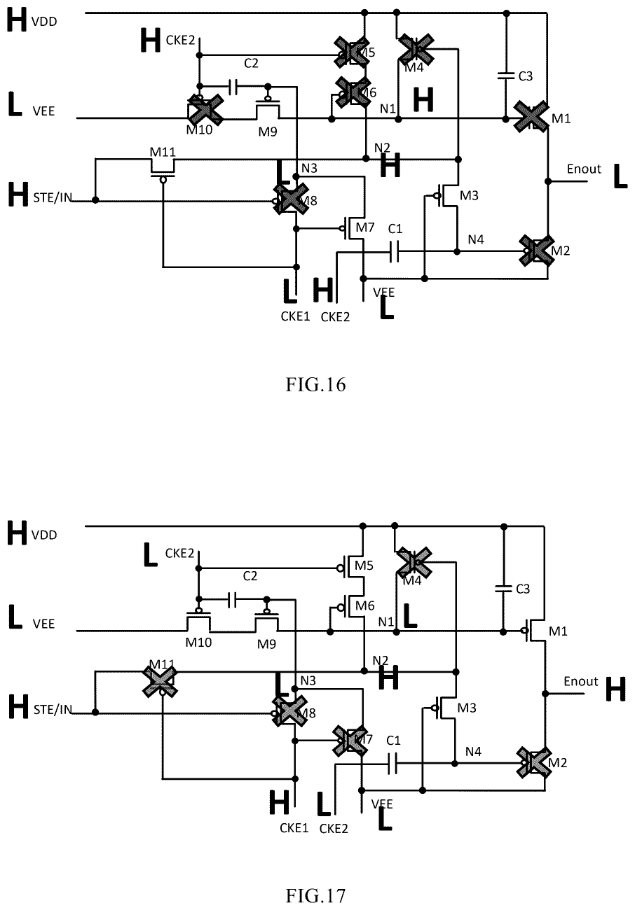

In the present embodiment, referring to FIGS. 15 and 16, in the process of Step 21, a high level is inputted into the signal input terminal IN, a low level is inputted into the first timing control signal line CKE1, and a high level is inputted into the second timing control signal line CKE2.

At this time, the third transistor M3, the seventh transistor M7, the ninth transistor M9 and the eleventh transistor M11 are turned on, and the first transistor M1, the second transistor M2, the fourth transistor M4, the fifth transistor M5, the sixth transistor M6, the eighth transistor M8 and the tenth transistor M10 are turned off. Specifically, a low level is inputted into the first timing control signal line CKE1, the seventh transistor M7 and the eleventh transistor M11 are turned on, and the second node N2 and the third node N3 are respectively written with the high level of the signal input terminal IN and the low potential of the second power supply VEE.

The high potential of the second node N2 causes the second transistor M2 and the fourth transistor M4 to be turned off, and the low potential of the third node N3 causes the ninth transistor M9 to be turned on. The second timing control signal line CKE2 is inputted with a high level, the fifth transistor M5 and the tenth transistor M10 are turned off, the first node N1 maintains the high potential at the previous moment, and the first transistor M1 and the sixth transistor M6 are turned off. Finally, the signal output terminal Enout maintains the low potential at the previous moment.

In the present embodiment, referring to FIGS. 15 and 17, in the process of Step 22, the signal input terminal IN is inputted with a high level, the first timing control signal line CKE1 is inputted with a high level, and the second timing control signal line CKE2 is inputted with a low level. At this time, the first transistor M1, the third transistor M3, the fifth transistor M5, the sixth transistor M6, the ninth transistor M9 and the tenth transistor M10 are turned on, and the second transistor M2, the fourth transistor M4, the seventh transistor M7, the eighth transistor M8 and the eleventh transistor M11 are turned off. Specifically, the first timing control signal line CKE1 is inputted with a high level, the seventh transistor M7 and the eleventh transistor M11 are turned off, the third node N3 maintains the low potential at the previous moment, and the ninth transistor M9 is turned on. At the same time, the second timing control signal line CKE2 is inputted with a low level, the fifth transistor M5 and the tenth transistor M10 are turned on, the first node N1 is written with the low potential of the second power supply VEE due to the turning on of the ninth transistor M9 and the tenth transistor M10, the first transistor M1 and the sixth transistor M6 are turned on, and the second node N2 is written with the high potential of the first power supply VDD due to the turning on of the fifth transistor M5 and the sixth transistor M6. The high potential of the second node N2 causes the second transistor M2 to be turned off, and the low potential of the first node N1 causes the first transistor MI to be turned on. Finally, the signal output terminal Enout outputs the high potential of the first power supply VDD.

In this embodiment, referring to FIGS. 15 and 18, in the process of Step 23, the signal input terminal IN is inputted with a high level, the first timing control signal line CKE1 is inputted with a low level, and the second timing control signal line CKE2 is inputted with a high level.

At this time, the first transistor M1, the third transistor M3, the sixth transistor M6, the seventh transistor M7, the ninth transistor M9 and the eleventh transistor M11 are turned on, and the second transistor M2, the fourth transistor M4, the fifth transistor M5, the eighth transistor M8 and the tenth transistor M10 are turned off. Specifically, the first timing control signal line CKE1 is inputted with a low level, the seventh transistor M7 and the eleventh transistor M11 are turned on, and the second node N2 and the third node N3 are respectively written with the high potential of the signal input terminal IN and the low potential of the second power supply VEE. The high potential of the second node N2 causes the second transistor M2 and the fourth transistor M4 to be turned off, and the low potential of the third node N3 causes the sixth transistor M6 and the ninth transistor M9 to be turned on. At the same time, the second timing control signal line CKE2 is inputted with a high level, the fifth transistor M5 and the tenth transistor M10 are turned off, and the first node N1 maintains the low potential of the previous moment. The high potential of the second node N2 causes the second transistor M2 to be turned off, and the low potential of the first node N1 causes the first transistor M1 to be turned on.

Finally, the signal output terminal Enout outputs the high potential of the first power supply VDD.

In the present embodiment, referring to FIGS. 15 and 19, in the process of Step 24, the signal input terminal IN is inputted with a high level, the first timing control signal line CKE1 is inputted with a high level, and the second timing control signal line CKE2 is inputted with a low level. At this time, the first transistor M1, the third transistor M3, the fifth transistor M5, the sixth transistor M6, the ninth transistor M9 and the tenth transistor M10 are turned on, and the second transistor M2, the fourth transistor M4, the seventh transistor M7, the eighth transistor M8 and the eleventh transistor M11 are turned off. Specifically, the first timing control signal line CKE1 is inputted with a high level, the seventh transistor M7 and the eleventh transistor M11 are turned off, the third node N3 maintains a low potential at the previous moment because the eighth transistor M8 is turned off due to the high level input to the signal input terminal IN, the ninth transistor M9 is turned on, and the first node N1 is written with the low potential of the second power supply VEE due to the turning on of the ninth transistor M9 and the tenth transistor M10. At the same time, the second timing control signal line CKE2 is inputted with a low level, and the second node N2 is written with a high potential of the first power supply VDD because the fifth transistor M5 and the sixth transistor M6 are turned on. The high potential of the second node N2 causes the second transistor M2 to be turned off, and the low potential of the first node N1 causes the first transistor M1 to be turned on. Finally, the signal output terminal Enout outputs the high potential of the first power supply VDD.

In this embodiment, referring to FIGS. 15 and 20, in the process of Step 25, the signal input terminal IN is inputted with a low level, the first timing control signal line CKE1 is inputted with a low level, and the second timing control signal line CKE2 is inputted with a high level.

At this time, the second transistor M2, the third transistor M3, the fourth transistor M4, the seventh transistor M7, the eighth transistor M8, the ninth transistor M9 and the eleventh transistor M11 are turned on, and the first transistor M1, the fifth transistor M5, the sixth transistor M6 and the tenth transistor M10 are turned off. Specifically, the first timing control signal line CKE1 is inputted with a low level, the second node N2 is written with the low level of the signal input terminal IN due to the turning on of the eleventh transistor M11, the third node N3 is written with the low potential of the first timing control signal line CKE1 and the second power supply VEE at the same time due to the turning on of the seventh transistor M7 and the eighth transistor M8, and the ninth transistor M9 is turned on. At the same time, the second timing control signal line CKE2 is inputted with a high level, the fifth transistor M5 and the tenth transistor M10 are turned off, and the first node N1 is written with the high potential of the first power supply VDD due to the turning on of the fourth transistor M4 caused by the low potential of the second node N2. The high potential of the first node N1 causes the first transistor M1 to be turned off, and the low potential of the second node N2 causes the second transistor M2 to be turned on. Finally, the signal output terminal Enout outputs the low potential of the second power source VEE.

In the present embodiment, referring to FIGS. 15 and 21, in the process of Step 26, the signal input terminal IN is inputted with a low level, the first timing control signal line CKE1 is inputted with a high level, and the second timing control signal line CKE2 is inputted with a low level. At this time, the second transistor M2, the third transistor M3, the fourth transistor M4, the fifth transistor M5, the eighth transistor M8, and the tenth transistor M10 are turned on, and the first transistor M1, the sixth transistor M6, the seventh transistor M7, the ninth transistor M9, and the eleventh transistor M11 are turned off. Specifically, the first timing control signal line CKE1 is inputted with a high level, the seventh transistor M7 and the eleventh transistor M11 are turned off, and the third node N3 is written with the high potential of the first timing control signal line CKE1 due to the eighth transistor M8 being turned on caused by the low potential input to the signal input terminal IN, and the ninth transistor M9 is turned off. At the same time, the second timing control signal line CKE2 is inputted with a low level, the fifth transistor M5 and the tenth transistor M10 are turned on, the second node N2 maintains the low potential of the previous moment, and the first node N1 is written with the high potential of the first power supply VDD due to the turning on of the fourth transistor M4 caused by the low potential of the second node N2. The high potential of the first node N1 causes the first transistor M1 to be turned off, and the low potential of the second node N2 causes the second transistor M2 to be turned on. Finally, the signal output terminal Enout outputs the low potential of the second power source VEE.

In this embodiment, the light-emitting driving unit repeats the processes from Step 25 to Step 26 after Step 26 until the next frame begins to be displayed, the start pulse signal STE or the signal input terminal IN are inputted with a high potential, and the next round process of Step 21 is re-entered.

In this embodiment, the relationship between the input and output of the light-emitting driving unit is: when the start pulse signal STE or the signal input terminal IN is inputted with a high-level signal at the beginning of a certain process, the signal output terminal Enout outputs a high-level signal when the next process starts; when the start pulse signal STE or the signal input terminal IN is inputted with a low-level signal in a certain process, the signal output terminal Enout outputs a low-level signal when the current process ends and the next process starts. At other times, the signal output by the signal output terminal Enout and the signal input by the start pulse signal STE or the signal input terminal IN are both low-level signals.

Based on the same inventive concept, an embodiment of the present disclosure further provides a display apparatus, including the display panel 10 provided in the embodiments of the present disclosure. The display apparatus may be any product or component with a display function, such as a mobile phone, a tablet computer, a television, a monitor, a notebook computer, a digital photo frame, a navigator, etc. The implementation of the display apparatus can refer to the embodiments of the display panel 10 above, and the repeated parts will not be repeated.

In summary, the light-emitting driving circuit and the display panel of the present disclosure provide a new light-emitting driving circuit, so that the first node N1, the second node N2 and the third node N3 are independently controlled to avoid the mutual restraint and influence of the three, thereby improving the output stability of the light-emitting driving unit, reducing the display abnormality of the display panel, and increasing the service life of the display panel; in addition, the present disclosure reduces the number of components of the light-emitting driving circuit by reducing the use of the timing control signal line, thereby reducing the border width of the display panel and adapting to the trend of narrow borders of display panels.

The above contents are further detailed descriptions of the present disclosure in combination with specific preferred embodiments, and it cannot be determined that the specific implementation of the present disclosure is limited to these descriptions. For ordinary technicians in the technical field to which the present disclosure belongs, several simple deductions or substitutions can be made without departing from the concept of the present disclosure, which should be regarded as falling within the scope of protection of the present disclosure.

1. A light-emitting driving circuit, comprising light-emitting driving units of multiple stages, wherein the light-emitting driving unit comprises a control module, a reset module and an output setting module;
the control module comprises:
a seventh transistor, wherein a first electrode of the seventh transistor is connected to a third node, a second electrode of the seventh transistor is connected to a second power supply, and a gate of the seventh transistor is connected to a first timing control terminal;
an eighth transistor, wherein a first electrode of the eighth transistor is connected to the third node, a second electrode of the eighth transistor is connected to the first timing control terminal, and a gate of the eighth transistor is connected to a signal input terminal; and
a ninth transistor, wherein a second electrode of the ninth transistor is connected to a first node;
the reset module comprises:
a fourth transistor, wherein a first electrode of the fourth transistor is connected to a first power supply, a second electrode of the fourth transistor is connected to the first node, and a gate of the fourth transistor is connected to a second node;
a fifth transistor, wherein a first electrode of the fifth transistor is connected to the first power supply, and a gate of the fifth transistor is connected to a second timing control terminal; and
a sixth transistor, wherein a first electrode of the sixth transistor is connected to a second electrode of the fifth transistor, and a second electrode of the sixth transistor is connected to the second node.

2. The light-emitting driving circuit according to claim 1, wherein the control module further comprises:
a twelfth transistor, wherein a first electrode of the twelfth transistor is connected to a gate of the ninth transistor, a second electrode of the twelfth transistor is connected to the third node, and a gate of the twelfth transistor is connected to the second power supply;
a gate of the sixth transistor is connected to the third node.

3. The light-emitting driving circuit according to claim 1, wherein the gate of the ninth transistor is connected to the third node;
a gate of the sixth transistor is connected to the first node.

4. The light-emitting driving circuit according to claim 2, wherein the output setting module comprises:
a first transistor, wherein a first electrode of the first transistor is connected to the first power supply, a second electrode of the first transistor is connected to a signal output terminal, and a gate of the first transistor is connected to the first node;
a second transistor, wherein a first electrode of the second transistor is connected to the signal output terminal, and a second electrode of the second transistor is connected to the second power supply, and a gate of the second transistor is connected to a fourth node;
a third transistor, wherein a first electrode of the third transistor is connected to the second node, a second electrode of the third transistor is connected to the fourth node, and a gate of the third transistor is connected to the second power supply;
a tenth transistor, wherein a first electrode of the tenth transistor is connected to the second power supply, a second electrode of the tenth transistor is connected to a first electrode of the ninth transistor, and a gate of the tenth transistor is connected to the second timing control terminal; and
an eleventh transistor, wherein a first electrode of the eleventh transistor is connected to the signal input terminal, a second electrode of the eleventh transistor is connected to the second node, and a gate of the eleventh transistor is connected to the first timing control terminal.

5. The light-emitting driving circuit according to claim 4, wherein the light-emitting driving unit further comprises:
a first capacitor, wherein a first electrode of the first capacitor is connected to the second timing control terminal, and a second electrode of the first capacitor is connected to the fourth node;
a second capacitor, wherein a first electrode of the second capacitor is connected to the second timing control terminal, and a second electrode of the second capacitor is connected to the gate of the ninth transistor; and
a third capacitor, wherein a first electrode of the third capacitor is connected to the first power supply, and a second electrode of the third capacitor is connected to the first node.

6. The light-emitting driving circuit according to claim 5, further comprising a timing controller, wherein the timing controller comprises a first timing control signal line and a second timing control signal line.

7. The light-emitting driving circuit according to claim 6, wherein the first timing control signal line is used to output a first timing control signal; and the second timing control signal line is used to output a second timing control signal.

8. The light-emitting driving circuit according to claim 7, wherein the first timing control signal and the second timing control signal are square wave signals with a same output frequency and a phase difference of 180°.

9. The light-emitting driving circuit according to claim 7, wherein the light-emitting driving unit is used to perform delay processing on a signal received from the signal input terminal under a control of the first timing control signal and the second timing control signal, and the processed signal is output by the signal output terminal.

10. The light-emitting driving circuit according to claim 6, wherein a light-emitting driving unit of a previous stage outputs a light-emitting driving signal to a light-emitting driving unit of a next stage, and a light-emitting driving unit of a last stage outputs a light-emitting driving signal.

11. The light-emitting driving circuit according to claim 10, wherein in a light-emitting driving unit of an odd-numbered stage, the first timing control terminal is connected to the first timing control signal line, and the second timing control terminal is connected to the second timing control signal line.

12. The light-emitting driving circuit according to claim 11, wherein in a light-emitting driving unit of an even-numbered stage, the first timing control terminal is connected to the second timing control signal line, and the second timing control terminal is connected to the first timing control signal line.

13. The light-emitting driving circuit according to claim 4, wherein the first transistor to the eleventh transistor are all P-type MOS transistors.

14. A display panel, comprising a light-emitting driving circuit, comprising light-emitting driving units of multiple stages, wherein the light-emitting driving unit comprises a control module, a reset module and an output setting module;
the control module comprises:
a seventh transistor, wherein a first electrode of the seventh transistor is connected to a third node, a second electrode of the seventh transistor is connected to a second power supply, and a gate of the seventh transistor is connected to a first timing control terminal;
an eighth transistor, wherein a first electrode of the eighth transistor is connected to the third node, a second electrode of the eighth transistor is connected to the first timing control terminal, and a gate of the eighth transistor is connected to a signal input terminal; and
a ninth transistor, wherein a second electrode of the ninth transistor is connected to a first node;
the reset module comprises:
a fourth transistor, wherein a first electrode of the fourth transistor is connected to a first power supply, a second electrode of the fourth transistor is connected to the first node, and a gate of the fourth transistor is connected to a second node;
a fifth transistor, wherein a first electrode of the fifth transistor is connected to the first power supply, and a gate of the fifth transistor is connected to a second timing control terminal; and
a sixth transistor, wherein a first electrode of the sixth transistor is connected to a second electrode of the fifth transistor, and a second electrode of the sixth transistor is connected to the second node.

15. The display panel according to claim 14, wherein the control module further comprises:
a twelfth transistor, wherein a first electrode of the twelfth transistor is connected to a gate of the ninth transistor, a second electrode of the twelfth transistor is connected to the third node, and a gate of the twelfth transistor is connected to the second power supply;
a gate of the sixth transistor is connected to the third node.

16. The display panel according to claim 14, wherein the gate of the ninth transistor is connected to the third node;
a gate of the sixth transistor is connected to the first node.

17. The display panel according to claim 15, wherein the output setting module comprises:
a first transistor, wherein a first electrode of the first transistor is connected to the first power supply, a second electrode of the first transistor is connected to a signal output terminal, and a gate of the first transistor is connected to the first node;
a second transistor, wherein a first electrode of the second transistor is connected to the signal output terminal, and a second electrode of the second transistor is connected to the second power supply, and a gate of the second transistor is connected to a fourth node;
a third transistor, wherein a first electrode of the third transistor is connected to the second node, a second electrode of the third transistor is connected to the fourth node, and a gate of the third transistor is connected to the second power supply;
a tenth transistor, wherein a first electrode of the tenth transistor is connected to the second power supply, a second electrode of the tenth transistor is connected to a first electrode of the ninth transistor, and a gate of the tenth transistor is connected to the second timing control terminal; and
an eleventh transistor, wherein a first electrode of the eleventh transistor is connected to the signal input terminal, a second electrode of the eleventh transistor is connected to the second node, and a gate of the eleventh transistor is connected to the first timing control terminal.

18. The display panel according to claim 17, wherein the light-emitting driving unit further comprises:
a first capacitor, wherein a first electrode of the first capacitor is connected to the second timing control terminal, and a second electrode of the first capacitor is connected to the fourth node;
a second capacitor, wherein a first electrode of the second capacitor is connected to the second timing control terminal, and a second electrode of the second capacitor is connected to the gate of the ninth transistor; and
a third capacitor, wherein a first electrode of the third capacitor is connected to the first power supply, and a second electrode of the third capacitor is connected to the first node.

19. The display panel according to claim 18, further comprising a timing controller, wherein the timing controller comprises a first timing control signal line and a second timing control signal line.

20. The display panel according to claim 19, wherein the first timing control signal line is used to output a first timing control signal; and the second timing control signal line is used to output a second timing control signal.
